(19) United States
(12) Patent Application Publication
(10) Pub. No.: US 2025/0156044 A1
(43) Pub. Date: May 15, 2025

(54) MULTI-COMPONENT DIRECT MAIL PACKAGE EDITOR

(71) Applicant: Bliss Media, Inc., St. Joseph, MN (US)

(72) Inventors: Joseph A. Leach, Clearwater, MN (US); Benjamin Jon Poorker, Baxter, MN (US)

(73) Assignee: Bliss Media, Inc., St. Joseph, MN (US)

(21) Appl. No.: 18/945,367

(22) Filed: Nov. 12, 2024

Related U.S. Application Data
(60) Provisional application No. 63/598,301, filed on Nov. 13, 2023.

(51) Int. Cl. G06F 3/0484; G06F 9/451; G06F 40/14

(52) U.S. Cl. CPC G06F 3/0484; G06F 9/451; G06F 40/14

(57) ABSTRACT

The present disclosure provides a direct-mail component editing system. The direct-mail component editing system is configured to create direct mail packages and includes a computing device coupled to a display and a printer. During operation, a user can use computing device to design components for a direct-mail mailer, which will be rendered on a graphical user interface and displayed displayed on display as it will be printed by printer. Further, the direct mail component editing system is configured to provide “free form” editing of the content of the components of the package.

### CROSS-REFERENCE TO RELATED APPLICATION

The present application claims priority to U.S. Provisional Application No. 63/598,301, filed on Nov. 13, 2023, the contents of which are incorporated herein by reference.

### TECHNICAL FIELD

The present disclosure relates to multi-component direct mail packages and particularly relates to an editor for creating such packages.

### BACKGROUND

Direct mail is a common form of direct marketing and is often employed by for-profit businesses, charities and other non-profits, political campaigns, and other organizations. Direct mail encompasses a wide variety of marketing materials, including brochures, catalogs, postcards, newsletters, and sales letters. Computers, executing an editor, is often used to design and print the components of the direct mailing. Some computer executable editors provide a “what you see is what you get” (WYSIWYG) system in which the editor displays created content in a form that resembles its appearance when printed.

### BRIEF SUMMARY

One example is a direct-mail component editor system. The system includes a processor and a memory comprising instructions. The instructions, which when executed by the processor, cause the system to: receive, from a user, an indication of a package of a direct mail mailer; identify, from a data-object defining the package, components of the package; identify, from a data-object defining the components, sub-components of the package; generate, from a data-object defining the sub-components of the package, a graphical user interface (GUI), the GUI comprising a canvas for each one of the sub-components, wherein the canvas comprises an editable graphical depiction of the sub-components; receiving an indication of a user generated edit to at least one sub-component of the package; converting the user generated edit from a first data format to a second a data format; and storing the user generated edit in the second data format to a memory storage location.

Alternatively or additionally to any of the examples herein, the first data format is hypertext markup language (HTML) or HTML 5.

Alternatively or additionally to any of the examples herein, the second data format is java script object notation (JSON), extensible markup language (XML), or YAML ain′t markup language (YAML).

Alternatively or additionally to any of the examples herein, the instructions when executed to generate, from the data-object defining the sub-components of the package, the GUI further cause the system to: identify, for a first one of the sub-components, dimensions of the first sub-component; generate the canvas for the first sub-component based in part on the dimensions of the first sub-component; add fixed elements for the first sub-component to the canvas; add user editable elements for the first sub-component to the canvas; and store an indication of the canvas for the first sub-component to the memory storage location.

Alternatively or additionally to any of the examples herein, the instructions when executed to generate, from the data-object defining the sub-components of the package, the GUI further cause the system to: identify, for a second one of the sub-components, dimensions of the second sub-component; generate the canvas for the second sub-component based in part on the dimensions of the sub-component; add fixed elements for the second sub-component to the canvas; add user editable elements for the second sub-component to the canvas; and store an indication of the canvas for the second sub-component to the memory storage location.

Alternatively or additionally to any of the examples herein, the GUI comprises a component navigation bar comprising an indication of the first sub-component and the second sub-component and wherein the instructions when executed to generate, from the data-object defining the sub-components of the package, the GUI further cause the system to: determine whether the first sub-component or the second sub-component is selected in the navigation bar; and center the canvas for the first sub-component in the GUI based on a determination that the first sub-component is selected in the navigation bar; or center the canvas for the second sub-component in the GUI based on a determination that the second sub-component is selected in the navigation bar.

Alternatively or additionally to any of the examples herein, the second data format defines an X and Y coordinate of at least one user generated element with respect to a one of the canvases.

Alternatively or additionally to any of the examples herein, the system is a software-as-a-service (SaaS) system accessible over the Internet.

Another example is a computer-readable storage medium, comprising instructions that when executed by a processor of a direct-mail component editor system cause the system to: receive, from a user, an indication of a package of a direct mail mailer; identify, from a data-object defining the package, components of the package; identify, from a data-object defining the components, sub-components of the package; generate, from a data-object defining the sub-components of the package, a graphical user interface (GUI), the GUI comprising a canvas for each one of the sub-components, wherein the canvas comprises an editable graphical depiction of the sub-components; receiving an indication of a user generated edit to at least one sub-component of the package; converting the user generated edit from a first data format to a second a data format; and storing the user generated edit in the second data format to a memory storage location.

Alternatively or additionally to any of the examples herein, the first data format is hypertext markup language (HTML) or HTML 5.

Alternatively or additionally to any of the examples herein, the second data format is java script object notation (JSON), extensible markup language (XML), or YAML ain′t markup language (YAML).

Alternatively or additionally to any of the examples herein, the instructions when executed to generate, from the data-object defining the sub-components of the package, the GUI further cause the system to: identify, for a first one of the sub-components, dimensions of the first sub-component; generate the canvas for the first sub-component based in part on the dimensions of the first sub-component; add fixed elements for the first sub-component to the canvas; add user editable elements for the first sub-component to the canvas; and store an indication of the canvas for the first sub-component to the memory storage location.

Alternatively or additionally to any of the examples herein, the instructions when executed to generate, from the data-object defining the sub-components of the package, the GUI further cause the system to: identify, for a second one of the sub-components, dimensions of the second sub-component; generate the canvas for the second sub-component based in part on the dimensions of the sub-component; add fixed elements for the second sub-component to the canvas; add user editable elements for the second sub-component to the canvas; and store an indication of the canvas for the second sub-component to the memory storage location.

Alternatively or additionally to any of the examples herein, the GUI comprises a component navigation bar comprising an indication of the first sub-component and the second sub-component and wherein the instructions when executed to generate, from the data-object defining the sub-components of the package, the GUI further cause the system to: determine whether the first sub-component or the second sub-component is selected in the navigation bar; and center the canvas for the first sub-component in the GUI based on a determination that the first sub-component is selected in the navigation bar; or center the canvas for the second sub-component in the GUI based on a determination that the second sub-component is selected in the navigation bar.

Alternatively or additionally to any of the examples herein, the second data format defines an X and Y coordinate of at least one user generated element with respect to a one of the canvases.

Another example is a computer implemented method for a direct-mail component editor system. The method includes: receiving, at a processor of a direct-mail component editor system from a user of the system, an indication of a package of a direct mail mailer; identifying, by the processor from a data-object defining the package, components of the package; identifying, by the processor from a data-object defining the components, sub-components of the package; generating, by the processor from a data-object defining the sub-components of the package, a graphical user interface (GUI), the GUI comprising a canvas for each one of the sub-components, wherein the canvas comprises an editable graphical depiction of the sub-components; receiving, by the processor from the user, an indication of a user generated edit to at least one sub-component of the package; converting, by the processor, the user generated edit from a first data format to a second a data format; and storing, by the processor, the user generated edit in the second data format to a memory storage location.

Alternatively or additionally to any of the examples herein, the first data format is hypertext markup language (HTML) or HTML 5.

Alternatively or additionally to any of the examples herein, the second data format is java script object notation (JSON), extensible markup language (XML), or YAML ain′t markup language (YAML).

Alternatively or additionally to any of the examples herein, the method further includes: identifying, by the processor for a first one of the sub-components, dimensions of the first sub-component; generating, by the processor, the canvas for the first sub-component based in part on the dimensions of the first sub-component; adding, by the processor, fixed elements for the first sub-component to the canvas; adding, by the processor, user editable elements for the first sub-component to the canvas; and storing, by the processor, an indication of the canvas for the first sub-component to the memory storage location.

Alternatively or additionally to any of the examples herein, wherein the method further includes: identifying, by the processor, for a second one of the sub-components, dimensions of the second sub-component; generating, by the processor, the canvas for the second sub-component based in part on the dimensions of the sub-component; adding, by the processor, fixed elements for the second sub-component to the canvas; adding, by the processor, user editable elements for the second sub-component to the canvas; storing, by the processor, an indication of the canvas for the second sub-component to the memory storage location; determining, by the processor, whether the first sub-component or the second sub-component is selected in the navigation bar; and centering, by the processor, the canvas for the first sub-component in the GUI based on a determination that the first sub-component is selected in the navigation bar; or centering, by the processor, the canvas for the second sub-component in the GUI based on a determination that the second sub-component is selected in the navigation bar.

### BRIEF DESCRIPTION OF THE SEVERAL VIEWS OF THE DRAWINGS

To easily identify the discussion of any element or act, the most significant digit or digits in a reference number refer to the figure number in which that element is first introduced.

FIG. 1 illustrates direct-mail component editing system 100, in accordance with at least one embodiment of the present disclosure.

FIG. 2A, 2B, 2C, 2D, 2E, and 2F illustrates a GUI, in accordance with at least one embodiment of the present disclosure.

FIG. 3 illustrates a logic flow for a direct-mail component editing system, in accordance with at least one embodiment of the disclosure.

FIG. 4 illustrates a data structure in a second data format, in accordance with at least one embodiment of the disclosure.

FIG. 5 illustrates another logic flow for a direct-mail component editing system, in accordance with at least one embodiment of the disclosure.

FIG. 6 illustrates yet another logic flow for a direct-mail component editing system, in accordance with at least one embodiment of the disclosure.

FIG. 7 illustrates still another logic flow for a direct-mail component editing system, in accordance with at least one embodiment of the disclosure.

FIG. 8A, 8B, and 8C illustrate print proofs for direct-mail components, in accordance with at least one embodiment of the disclosure.

FIGS. 9A and 9B illustrate print layouts for direct-mail components depicted in the print proofs of FIGS. 8A, 8B, and 8C, in accordance with at least one embodiment of the disclosure.

FIG. 10 illustrates a computer-readable storage medium in accordance with at least one embodiment of the disclosure.

FIG. 11 illustrates a cloud based direct-mail component editing system in accordance with at least one embodiment of the disclosure.

FIG. 12 illustrates a diagrammatic representation of a machine in the form of a computer system within which a set of instructions may be executed for causing the machine to perform any one or more of the methodologies discussed herein, according to an example embodiment.

### DETAILED DESCRIPTION

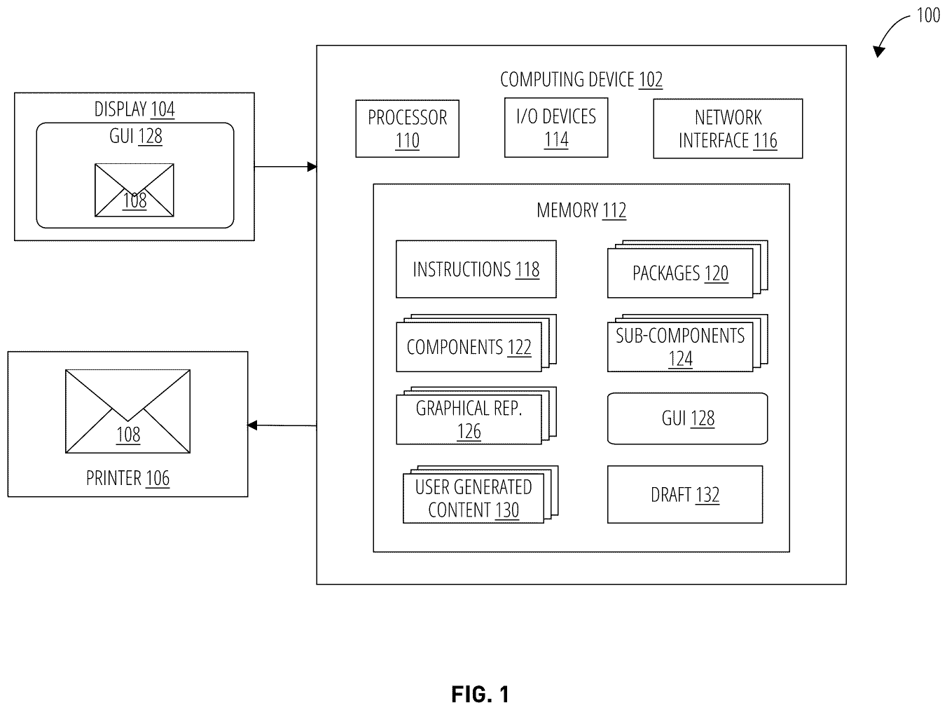

FIG. 1 illustrates a direct-mail component editing system 100, in accordance with non-limiting examples of the present disclosure. In general, direct-mail component editing system 100 is a system for creating direct mail packages. Direct-mail component editing system 100 includes a computing device 102 coupled to a display 104 and a printer 106. During operation, a user can use computing device 102 to design components for a direct-mail mailer 108. During the design and creation process, the direct-mail mailer 108 can be displayed on display 104 as it will be printed by printer 106.

Computing device 102 can be any of a variety of computing devices. In some embodiments, computing device 102 can be a workstation or communicatively coupled to display 104 and printer 106. With some embodiments, computing device 102 can be provided by a cloud computing system, such as, by a computing as a service system (e.g., laaS, PaaS, or the like) accessibly over a network (e.g., the Internet). In such an example, display 104 can itself be a computing device having comparable components to computing device 102 (e.g., a processor, memory, I/O devices, a network interface, etc.) and display 104. For example, display 104 could be embodied by a tablet, a laptop, a workstation, or the like, which can be communicatively coupled to computing device 102 via a network (e.g., the Internet, or the like).

Computing device 102 can include processor 110, memory 112, input and/or output (I/O) devices 114, and network interface 116. With some embodiments, particularly where display 104 is itself a computing device and where computing device 102 is provided as a cloud computing system, input and/or output (I/O) devices 114 can be provided by display 104.

The processor 110 may include circuitry or processor logic, such as, for example, any of a variety of commercial processors. In some examples, processor 110 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processor 110 may include graphics processing portions and may include dedicated memory, multiple-threaded processing and/or some other parallel processing capability. In some examples, the processor 110 may be an application specific integrated circuit (ASIC) or a field programmable integrated circuit (FPGA).

The memory 112 may include logic, a portion of which includes arrays of integrated circuits, forming non-volatile memory to persistently store data or a combination of non-volatile memory and volatile memory. It is to be appreciated, that the memory 112 may be based on any of a variety of technologies. In particular, the arrays of integrated circuits included in memory 120 may be arranged to form one or more types of memory, such as, for example, dynamic random access memory (DRAM), NAND memory, NOR memory, or the like.

I/O devices 114 can be any of a variety of devices to receive input and/or provide output. For example, I/O devices 114 can include, a keyboard, a mouse, a joystick, a foot pedal, a display, a touch enabled display, a haptic feedback device, an LED, or the like. Where display 104 is itself a stand along computing device and where computing device 102 is provided by a cloud computing system, input and/or output (I/O) devices 114 can be embodied in display 104 and used to relay inputs and outputs to computing device 102.

Network interface 116 can include logic and/or features to support a communication interface. For example, network interface 116 may include one or more interfaces that operate according to various communication protocols or standards to communicate over direct or network communication links. Direct communications may occur via use of communication protocols or standards described in one or more industry standards (including progenies and variants). For example, network interface 116 may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, or the like. Additionally, network interface 116 can include logic and/or features to enable communication over a variety of wired or wireless network standards (e.g., 802.11 communication standards). For example, network interface 116 may be arranged to support wired communication protocols or standards, such as, Ethernet, or the like. As another example, network interface 116 may be arranged to support wireless communication protocols or standards, such as, for example, Wi-Fi, Bluetooth, ZigBee, LTE, 5G, or the like.

Memory 112 can include instructions 118 and packages 120, components 122, and sub-components 124. It is noted that the terms components (e.g., components 122) and sub-components (e.g., sub-components 124) are used to distinguish different “parts” of a direct mail package 120. However, in practice all “parts” coupled be referred to as components. For example, components 122 and sub-components 124 could all be referred to as “components” for simplicity.

Packages 120 can comprise multiple different “types” of direct-mail mailings and refers to a group of several printed pieces (e.g., letters, reply slips, envelopes, etc.) that are packaged together for mailing through the US Post Office. Each one of packages 120 includes components 122. A components 122 is an individual printed piece that makes up a part of packages 120. For example, packages 120 can include a “Donor Renewal Package” that includes a “Letter” components 122, a “Remit” components 122, a “Reply Envelope” components 122 and an “Outer Envelope” components 122. Each components 122 can include multiple sub-components 124. Or rather, sub-components 124 can define the individual parts that make up a one of the components 122. For example, a “Letter” components 122 could have both a “Letter Front” and a “Letter Back” sub-components 124.

In general, processor 110 can execute instructions to provide WYSIWYG editing for any of the packages 120, where each packages 120 is defined by multiple components 122 each having multiple sub-components 124 to create a direct-mail mailer 108. During editing, processor 110 can execute instructions 118 to generate graphical representations 126 of the sub-components 124 of each components 122 in a packages 120 to be created as direct-mail mailer 108. The graphical representations 126 can be displayed on display 104 as a representation of direct-mail mailer 108.

With some embodiments, packages 120, components 122, and sub-components 124 are stored as a data object, such as, for example, a JavaScript Object Notation (JSON) data object. For example, the data objects defining each package of the packages 120 can include an indication of which one or ones of components 122 are included in the particular package of packages 120. Similarly, the data objects defining each component of the components 122 can include an indication of which one or ones of the sub-components 124 are included in the particular component. Finally, the data objects defining each sub-component of the sub-components 124 can include an indication of the physical dimensions of the sub-component, meta data defining placement of elements within the sub-component and static elements (e.g., bleeds, safe zones, trim lines, fold lines, and off-limit areas, etc.)

Processor 110 can execute instructions 118 to generate graphical representations 126 from the data-objects of each sub-components 124 for the components 122 in a packages 120 to be created as direct-mail mailer 108. Further, processor 110 can execute instructions 118 to generate a graphical user interface (GUI) 128 that can be displayed on display 104 and with which a user can view and edit a canvas for each sub-components 124 of the direct-mail mailer 108. With some embodiments, processor 110 can execute instructions 118 to generate GUI 128 viewable in a web browser (e.g., in Hypertext Markup Language (HTML), or the like). In particular, processor 110 can execute instructions 118 to generate GUI 128 in HTML from JSON data-objects of sub-components 124 for direct-mail mailer 108.

A user can interact with and/or modify the sub-components 124 via the GUI 128 by adding user generated content 130 to each sub-components 124. Processor 110 can execute instructions 118 to convert user generated content 130 from GUI 128 (e.g., HTML representation, or the like) to the data-object (e.g., JSON) used to define the sub-components 124 and store the user generated content 130 as a data-object. It is important to note that the graphical user interface (GUI) 128 is different from conventional WYSIWYG editors in that the GUI 128 provides free form editing of multiple components 122 of a packages 120 where each one of components 122 has sub-components 124 that define a canvas having dimensions and blocked off areas in which the user can free form edit the canvas. A user can add user generated content 130 which is represented in graphical user interface (GUI) 128 and stored as a data-object user generated content 130. The processor 110 can execute instructions 118 to convert the user generated content 130 from the format viewable in GUI 128 to the data-object format of user generated content 130 and back. This is described in greater detail below.

Further, processor 110 can execute instructions 118 to generate a printable representation of the sub-components 124 of direct-mail mailer 108 comprising the user generated content 130 and store the printable representation as draft 132. Processor 110 can execute instructions 118 to generate draft 132 from sub-components 124 and user generated content 130 based replacing (e.g., data merging, or the like) portions of sub-components 124 with user generated content 130. As a specific example, processor 110 can convert sub-components 124 into a web-viewable representation (e.g., HTML) merge user generated content 130 into the web-viewable representation, and then convert the web-viewable representation with the user generated content 130 into a printable representation (e.g., Portable Document Format (PDF), or the like).

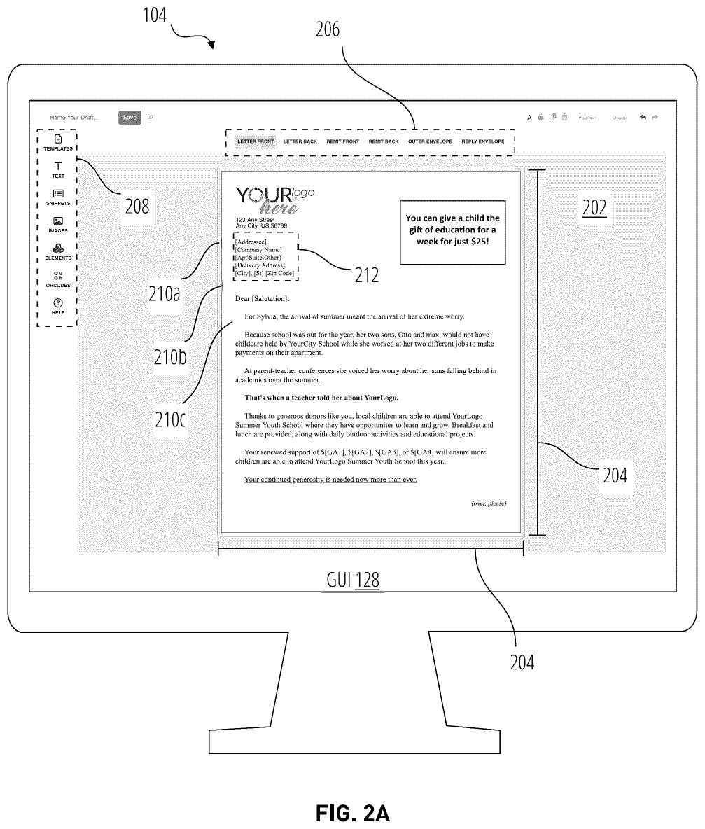

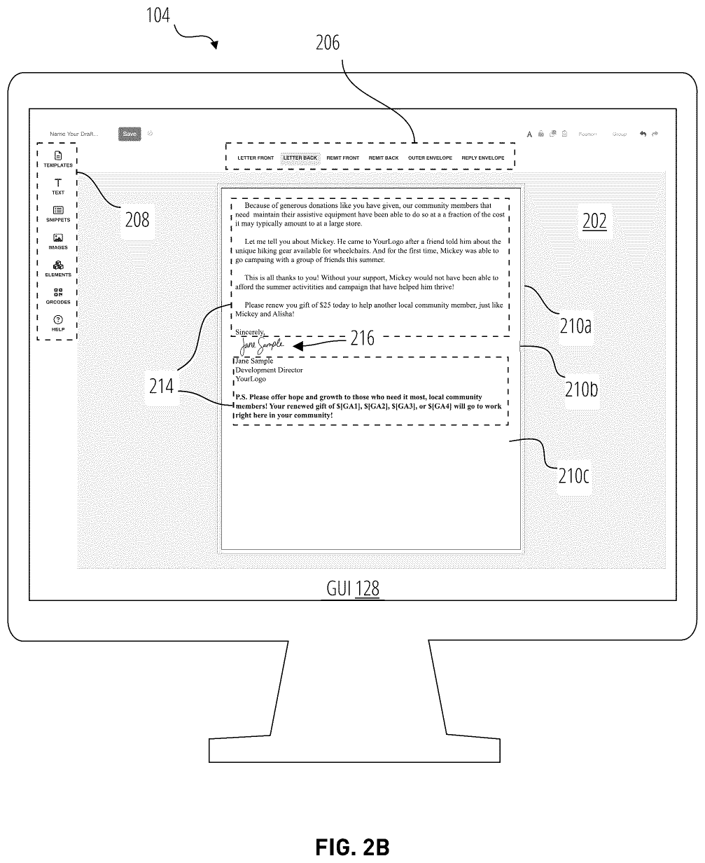

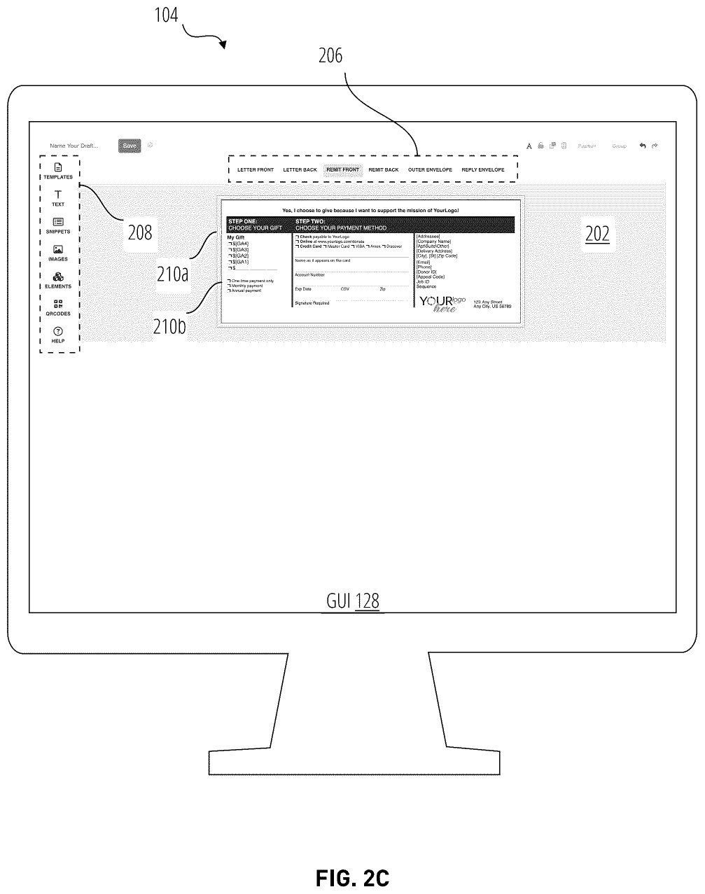

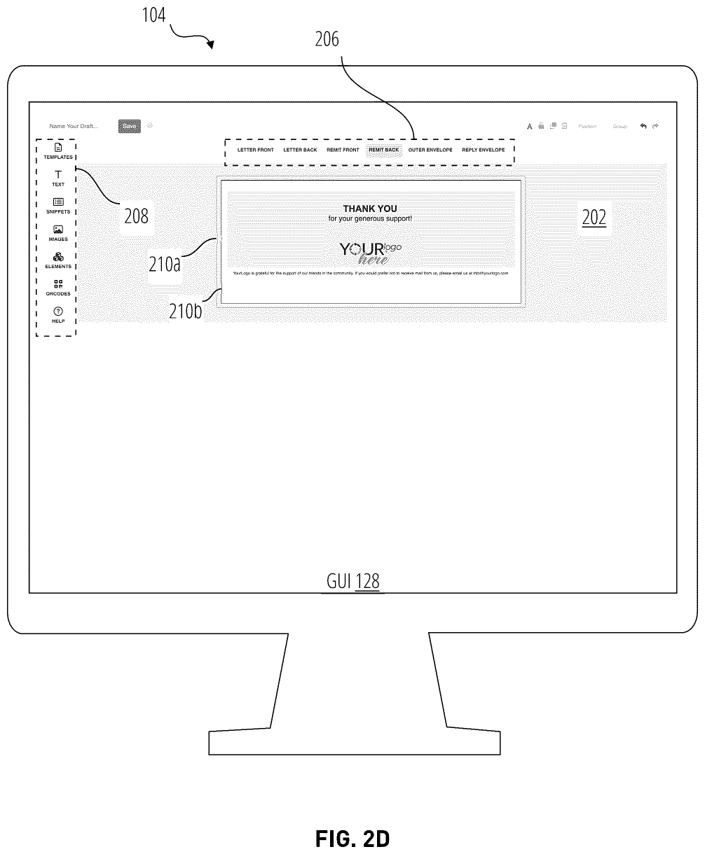

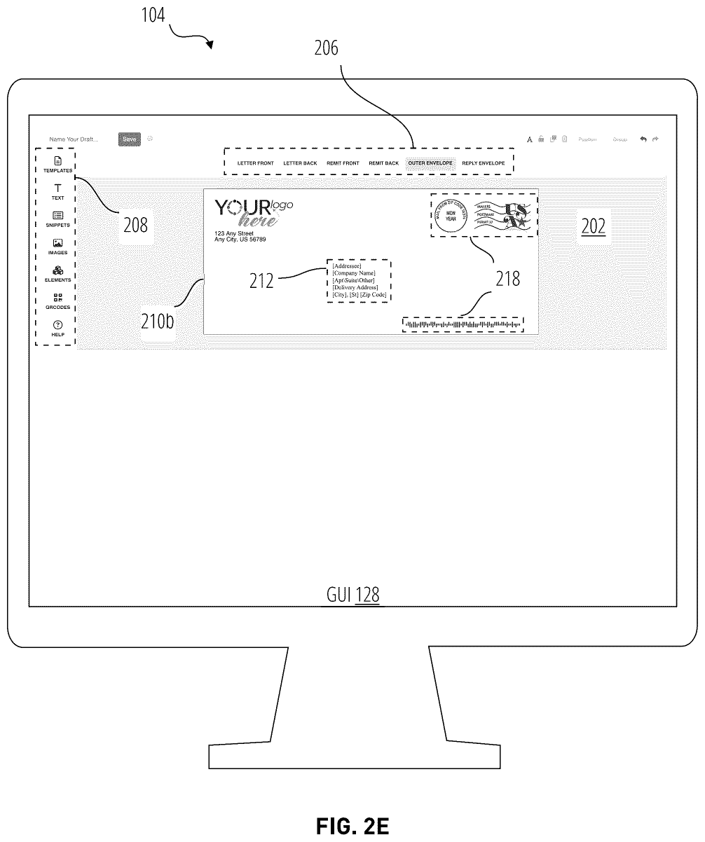

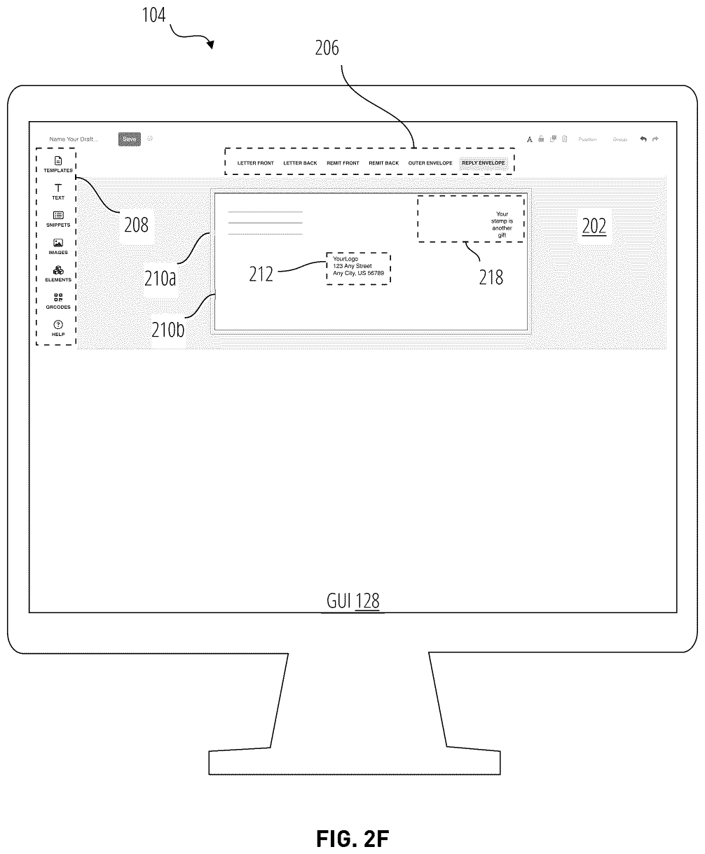

FIG. 2A to FIG. 2F illustrate examples of a GUI 128 that can be generated to allow editing of a direct-mail mailer 108. The example illustrated in these figures corresponds to a direct-mail mailer 108 for a “donor renewal” package of packages 120 that has letter, remit, reply envelope, and outer envelope components of components 122 and further where the letter and remit components 122 has a front and a back sub-component of sub-components 124.

Turning more particularly to FIG. 2A, which illustrates an example of a letter front one of sub-components 124 (e.g., corresponding to a letter one of components 122, or the like). As depicted, the GUI 128 can be generated comprising an indication of a particular sub-component of sub-components 124 from the packages 120 of direct-mail mailer 108. GUI 128 can include a navigation bar 206 in which one of the sub-components 124 of the direct-mail mailer 108 can be selected for viewing and/or editing. The selected one of the sub-components 124 can be displayed on canvas 202 in which the sub-component is depicted as it would be printed (e.g., based on dimensions 204, etc.), preformed portions, and/or user generated content 130.

Further, GUI 128 can include editing bar 208 providing various canvas editing tools (e.g., templates, text box, snippets, image, elements, QR codes, etc.) with which a user can edit and/or modify the canvas 202. Processor 110 can execute instructions 118 to receive indications (e.g., from I/O devices on a user computer in which display 104 is coupled) in a web-viewable format (e.g., HTML) and convert them to a data-object (e.g., JSON) and store the data-object as user generated content 130.

In some embodiments, canvas 202 for a particular sub-component of sub-components 124 can have blocked off or restricted areas. For example, canvas 202 may have various margins 210a, 210b, and/or 210c that may restrict or control, in some way, the editable portions of the canvas. For example, margins 210a may correspond to bleed lines. Background elements (e.g., background images, background colors, etc.) can extend to at least bleed lines, or margins 210a to ensure that the background elements will cover the entire background of the printed piece after it is trimmed. As another example, margins 210b may correspond to trim lines. Trim lines, or margins 210b represent the final size of printed piece after it is trimmed. With yet another example, margins 210c may correspond to safe zones. Safe zones, or margins 210c represent a region where it is recommended that a user keep content to ensure that the content is not cut off in the trimming process or does not appear or run too close to the edge of the final trimmed piece.

FIG. 2B illustrates an example of a letter back one of sub-components 124 (e.g., corresponding to a letter one of components 122, or the like). As depicted, the letter back has dimensions 204 (not called out) represented on canvas 202 and margins 210a, 210b, and 210c, which are indicated in this figure. All other areas of the canvas 202 are editable. For example, text can be added in text blocks 214 while a signature can be added as image 216. Processor 110 can execute instructions 118 to convert margins 210 and 216 to data-objects and store them as user generated content 130. Subsequently, if the letter back one of sub-components 124 for the direct-mail mailer 108 is redisplayed, the user generated content 130 can be converted from the data-object to web-viewable content and displayed on GUI 128 as shown. This user generated content 130 could be edited and/or modified and the modified content reconverted to data-object format and stored as user generated content 130.

FIG. 2C illustrates an example of a remit front one of sub-components 124 (e.g., corresponding to a remit one of components 122, or the like). As depicted, the remit front has dimensions 204 (not called out) represented on canvas 202. However, only the bleed lines, or margins 210a and trim lines, or margins 210b are represented on this sub-component, as such, all areas of the canvas 202 are editable. This sub-component can be edited as described herein.

Likewise, FIG. 2D illustrates an example of a remit back one of sub-components 124 (e.g., corresponding to a remit one of components 122, or the like). As depicted, the remit back has dimensions 204 (not called out) represented on canvas 202. Like the canvas depicted in FIG. 2C, only the bleed lines, or margins 210a and trim lines, or margins 210b are represented on this sub-component, as such, all areas of the canvas 202 are editable. This sub-component can also be edited as described herein.

FIG. 2E illustrates an example of an outside envelope one of sub-components 124 (e.g., corresponding to an envelope one of components 122, or the like). As depicted, the envelope has dimensions 204 (not called out) represented on canvas 202. Further, certain areas may be blocked off or restricted from editing, such as, address block 212, USPS reserved areas 218, or the like. Further, this sub-component includes trim lines, or margins 210b. This sub-component can be edited as described herein.

FIG. 2F illustrates an example of a remit envelope one of sub-components 124 (e.g., corresponding to an envelope one of components 122, or the like). As depicted, the envelope has dimensions 204 (not called out) represented on canvas 202. Further, certain areas may be blocked off or restricted from editing, such as, address block 212, USPS reserved areas 218, or the like. Further, this sub-component includes bleed lines, or margins 210a and trim lines, or margins 210b. This sub-component can be edited as described herein.

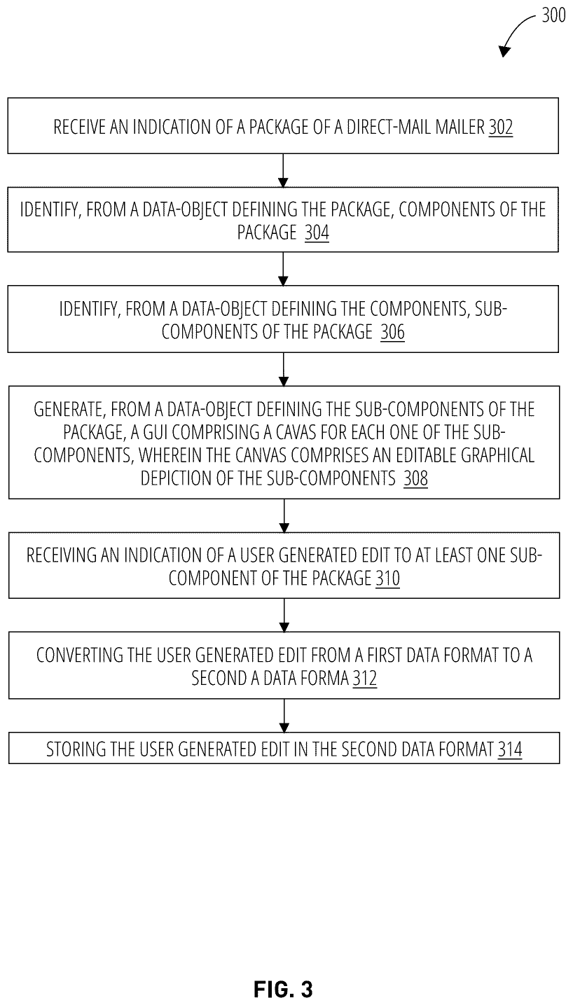

FIG. 3 illustrates a logic flow 300 that can be implemented by a computing system configured to enable editing of a multi-component direct-mail mailer package. For example, logic flow 300 can be implemented by direct-mail component editing system 100 of FIG. 1. Logic flow 300 can begin at block 302. At block 302 “receive an indication of a package of a direct-mail mailer” an indication of a package of a direct mail mailer can be received. For example, processor 110 can execute instructions 118 to receive an indication of a one of packages 120 to generate.

Continuing to block 304 “identify, from a data-object defining the package, components of the package” and block 306 “identify, from a data-object defining the components, sub-components of the package” components and sub-components of the package can be identified from data objects defining the package and components. For example, processor 110 can execute instructions 118 to identify ones of components 122 corresponding to the package of packages 120 indicated at block 302 and to identify ones of the sub-components 124 corresponding to the components 122 identified by block 304.

Continuing to block 308 “generate, from a data-object defining the sub-components of the package, a GUI comprising a canvas for each one of the sub-components, wherein the canvas comprises an editable graphical depiction of the sub-components” a GUI comprising graphical indications of one or more of the sub-components of the package can be generated. For example, processor 110 can execute instructions 118 to generate GUI 128 comprising indications of ones of the sub-components 124 and further cause the GUI to be displayed on display 104. For example, processor 110 can execute instructions 118 to generate graphical user interface (GUI) 128 comprising navigation bar 206 in which a sub-components 124 of the packages 120 can be selected for viewing on the canvas 202.

Continuing to block 310 “receiving an indication of a user generated edit to at least one sub-component of the package” an indication of a user generated edit to a one of the sub-components 124 can be received. For example, an edit can be specified via the GUI 128. Similarly, processor 110 can execute instructions 118 to receive an indication of the edit via the GUI 128. For example, processor 110 can execute instructions 118 to receive an indication of an edit to the canvas 202 on which a one of the sub-components 124 is depicted.

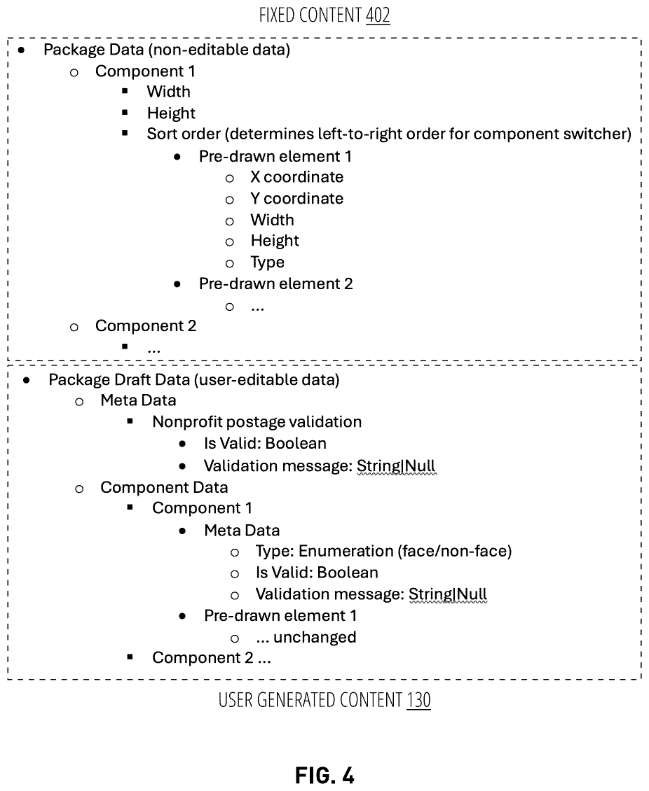

Continuing to block 312 “converting the user generated edit from a first data format to a second a data format” the user generated edit received at block 310 can be converted from a first data format to a second data format. For example, processor 110 can execute instructions 118 to convert a user generated edit (e.g., text blocks 214, image 216, etc.) from a first data format (e.g., HTML, HTML 5) to a second data format (e.g., JSON, XML, YAML, etc.). An example of a packages 120 stored in the second data format is given in FIG. 4 described in more detail below.

FIG. 4 illustrates an example description of a package of packages 120 in a hypothetical second data format. Although the syntax of the data format shown in FIG. 4 is not elaborated, the key elements are shown. For example, the package shows components (e.g., components 122, sub-components 124, etc.) with fixed content 402 and user generated content 130. In some embodiments, the second data format can define features of the user generated content 130, such as, for example, an X and Y coordinate of the user generated content 130 relative to the canvas 202, dimensions of the user generated content 130, a type of content (e.g., text, image, freeform, etc.). Further, the user generated content 130 can include, for example as meta data, tags associated with a validation on the package 120. For example, in some embodiments, the package can be validated for compliance with a non-profit mailing standard or requirement. As another example, the package 120 can be validated for compliance with a mailing standard, such as, a United States Postal Service (USPS) mailing standard or requirement.

Returning to FIG. 3, logic flow 300 can continuing to block 314 “storing the user generated edit in the second data format” the user generated edit can be stored in the second data format. For example, processor 110 can execute instructions 118 to store the user generated edit in the second data format at user generated content 130.

Furthermore, although not depicted in this figure, logic flow 300 could include retrieving the user generated edit in the second data format (e.g., from user generated content 130, or the like), converting it to the first data format, and displaying it on the GUI 128 for further manipulation or editing.

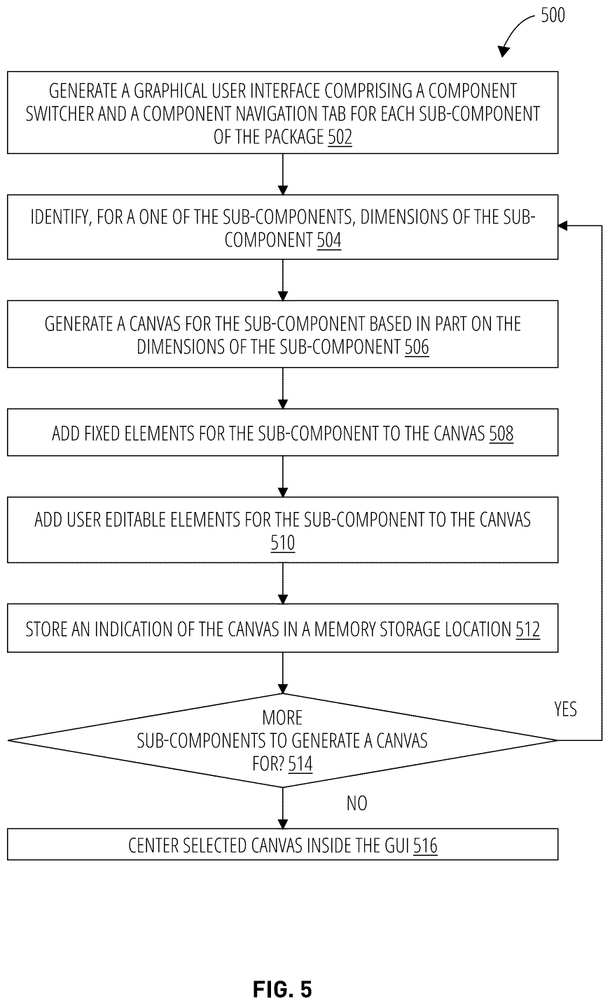

FIG. 5 illustrates a logic flow 500 that can be implemented by a computing system configured to enable editing of a multi-component direct-mail mailer package. For example, logic flow 500 can be implemented by direct-mail component editing system 100 of FIG. 1. In some embodiments, logic flow 500 can be implemented as part of logic flow 300 of FIG. 3. For example, processor 110 of direct-mail component editing system 100 can execute instructions 118 to cause direct-mail component editing system 100 to carry out operations for logic flow 500 at block 308 of logic flow 300. Logic flow 500 can begin at block 502. At block 502 “generate a graphical user comprising a component switcher and a component navigation tab for each sub-component of the package” a GUI comprising graphical indications and input selection elements for a component switcher and a component navigation tab can be generated. For example, processor 110 can execute instructions 118 to generate a GUI (e.g., GUI 128, or the like) comprising navigation bar 206 and editing bar 208.

Continuing to block 504 “identify, for a one of the sub-components, dimensions of the sub-component” dimensions of a one of the sub-components can be identified. For example, processor 110 can execute instructions 118 to identify dimensions 204 (e.g., width and height) of one of the sub-components 124. Continuing to block 506 “generate a canvas for the sub-component based in part on the dimensions of the sub-component” a canvas for the sub-component can be generated. For example, processor 110 can execute 118 to generate a canvas 202 based on the dimensions identified at block 504.

Continuing to block 508 “add fixed elements for the sub-component to the canvas” fixed elements for the sub-component can be added to the canvas. For example, processor 110 can execute instructions 118 to add fixed or non-editable elements for the sub-component to the canvas 202. In general, at block 508, processor 110 can execute 118 to iterate through all pre-drawn or “fixed” elements for the sub-component and render them on the canvas. Pre drawn elements are the parts of the canvas that a user cannot edit, such as, for example, trim lines, bleed lines, off-limit areas, fold lines, etc. For example, FIG. 2E shows canvas 202 having fixed elements (e.g., USPS reserved areas 218) drawn on the canvas 202. It is important to note that the present disclosure provides to separate pre-drawn or fixed elements from user editable elements to provide that the fixed elements can be updated without affecting the user editable elements.

Continuing to block 510 “add user editable elements for the sub-component to the canvas” user editable elements for the sub-component can be added to the canvas. For example, processor 110 can execute instructions 118 to add fixed or non-editable elements for the sub-component to the canvas 202. In general, at block 510, processor 110 can execute 118 to iterate through all user editable elements for the sub-component and render them on the canvas. User editable elements are the parts of the canvas that a user can edit such as, for example, anything not blocked by the fixed elements.

Continuing to block 512 “store an indication of the canvas in a memory storage location” an indication of the canvas can be stored to a memory storage location. For example, the canvas for the sub-component with the fixed and user editable elements can be stored as canvas 202 in memory 112. Continuing to decision block 514 “more sub-components to generate a canvas for?” a determination can be made as to whether more sub-component of the components need a canvas. For example, as outlined above, components 122 will often include multiple sub-components 124. Accordingly, logic flow 500 can be iterated through repeatedly to generate a canvas for each sub-components 124 of components 122. As such, at decision block 514, processor 110 can execute instructions 118 to determine whether more sub-components 124 need a canvas. From decision block 514, logic flow 500 can continue to block 516 or return to block 504. For example, logic flow 500 can continue from decision block 514 to block 516 based on a determination at decision block 514 that there are not more sub-components to generate a canvas for while logic flow 500 can return to block 504 from decision block 514 based on a determination at decision block 514 that there are more sub-components to generate a canvas for.

At block 516 “center selected canvas inside the GUI” the canvas for the selected sub-component can be centered in the GUI. For example, processor 110 can execute instructions 118 to center the canvas 202 within the GUI 128. In further embodiments, processor 110 can execute instructions 118 to draw guides (e.g., rulers, grids, etc.) within the graphical user interface (GUI) 128.

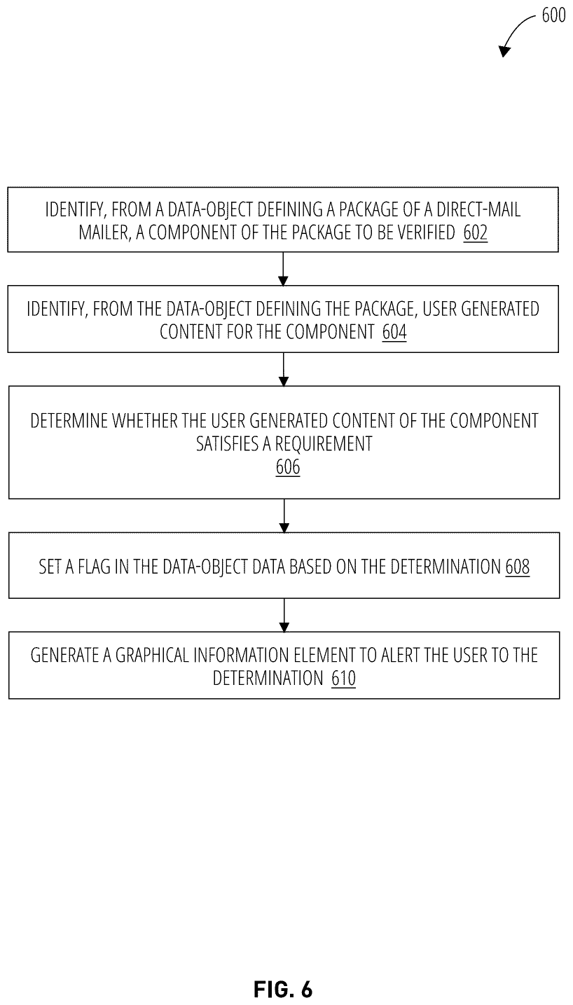

FIG. 6 illustrates a logic flow 600 that can be implemented by a computing system configured to enable editing and validation of a multi-component direct-mail mailer package. For example, logic flow 600 can be implemented by direct-mail component editing system 100 of FIG. 1. Logic flow 600 can begin at block 602. At block 602 “identify, from a data-object defining a package of a direct-mail mailer, a component of the package to be verified” a component (and sub-components) of a package to be verified can be identified from data objects defining the package and components. For example, processor 110 can execute instructions 118 to identify ones of components 122 corresponding to a package of packages 120. Continuing to block 604 “identify, from the data-object defining the package, user generated content for the component” user generated content for the component to be verified can be identified from the data-object. For example, processor 110 can execute instructions 118 to identify user generated content 130 of the component of component 122.

Continuing to block 606 “determine whether the user generated content of the component satisfies a requirement” a determination is made whether the user generated content of the component satisfies a requirement. For example, processor 110 can execute 118 to determine whether the user generated content 130 of the component of components 122 satisfies a requirement. With some embodiments, the requirement can be associated with non-profit mailer requirements. For example, the USPS has requirements for mailers to qualify for non-profit postage. As a specific example, the name and address of the non-profit must be displayed on the outer envelope or prominently within the contents of the mail piece, the return address, if included, must match that of the authorized nonprofit organization, and the name and address of the non-profit match information registered with the USPS. In this specific example, the processor 110 can execute instructions 118 to determine whether the component of components 122, including the user generated content 130 satisfies these requirements. As another example, USPS has specific requirements for locations of the address, barcode, return address, and postage on envelopes. In this specific example, the processor 110 can execute instructions 118 to determine whether the component of components 122, including the user generated content 130 satisfies the USPS position and content requirements for non-profit envelopes.

Continuing to block 608 “set a flag in the data-object based on the determination” a flag can be set in the data-object for the package to indicate whether the user generated content satisfies the requirement or not. For example, a Boolean flag can be used to indicate that the USPS requirements discussed above are met or not.

Continuing to block 610 “generate a graphical information element to alert the user to the determination” a graphical user information element comprising a visual indication of the determination can be generated. For example, processor 110 can execute instructions 118 to generate a graphical representation 126 to be displayed as part of GUI 128 that visually indicates to the user that status of the validation (e.g., passed or failed, qualifies for non-profit postage or does not quality, etc.)

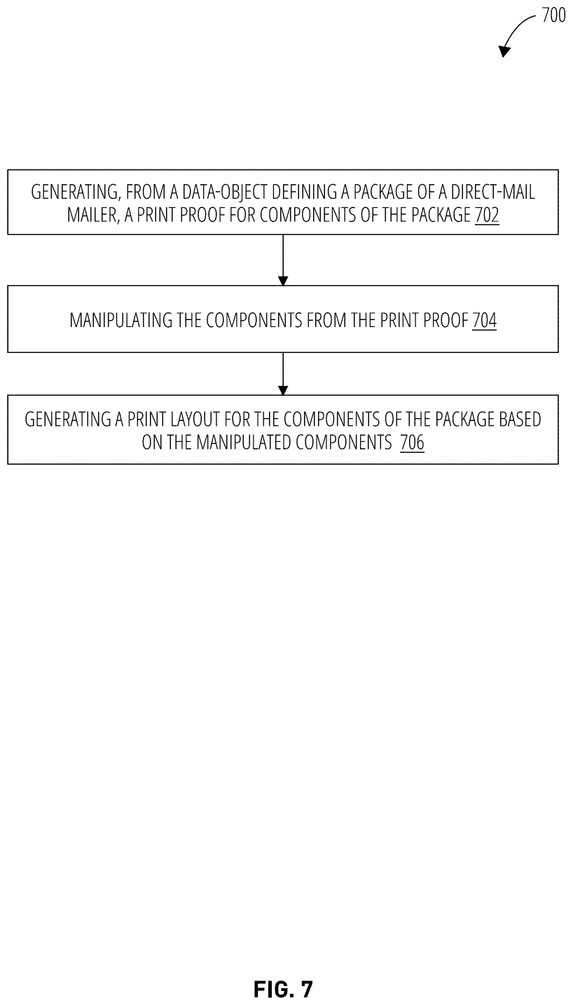

FIG. 7 illustrates a logic flow 700 that can be implemented by a computing system configured to generate print proofs and print layouts of a multi-component direct-mail mailer package. For example, logic flow 700 can be implemented by direct-mail component editing system 100 of FIG. 1. Logic flow 700 can begin at block 702. At block 702 “generate, from a data-object defining a package of a direct-mail mailer, a print proof for components of the package” components of a package of a direct-mail mailer can be printed as represented in the GUI discussed above. For example, processor 110 can execute instructions 118 to generate a print proof for ones of components 122 corresponding to a package of packages 120 where the print proof includes user generated content 130.

Continuing to block 704 “manipulate the components from the print proof” components from the print proof can be manipulated (e.g., rotated, resized, or the like). For example, processor 110 can execute instructions 118 to manipulate components of the print proof, such as, for example, rotating them 180 degrees.

Continuing to block 706 “generating a print layout for the components of the package based on the manipulated components” a print layout for the components of the package can be generated from the manipulated components. For example, processor 110 can execute instructions 118 to generate a print layout from the manipulated components. It is noted that not all components will be manipulated in all embodiments.

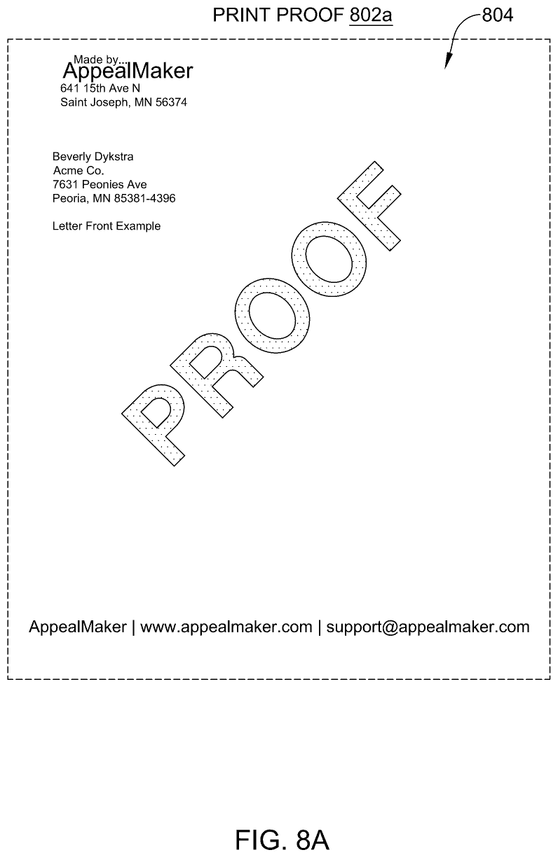

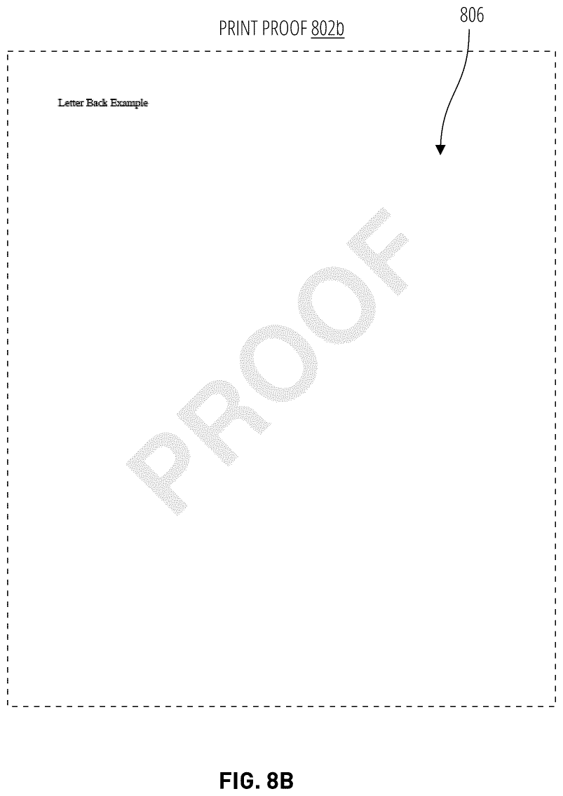

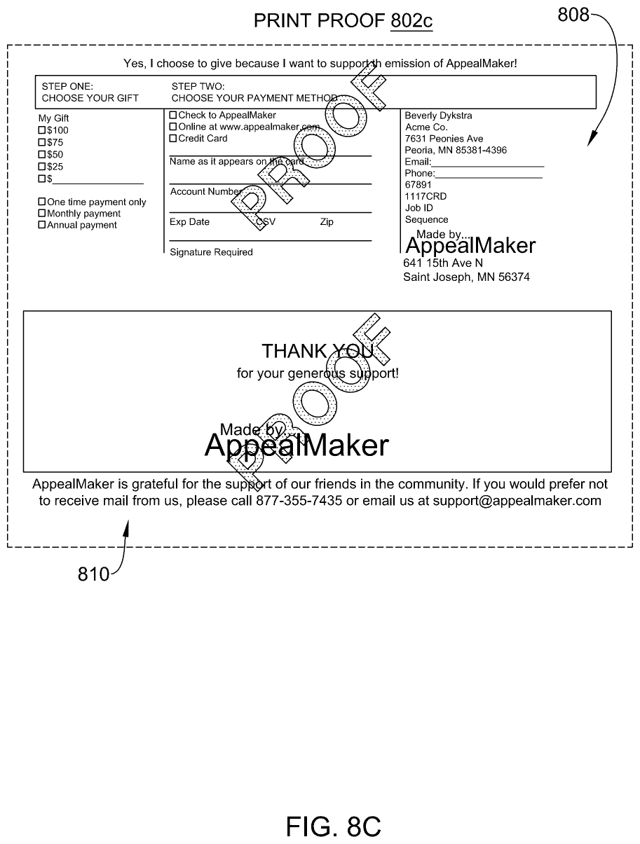

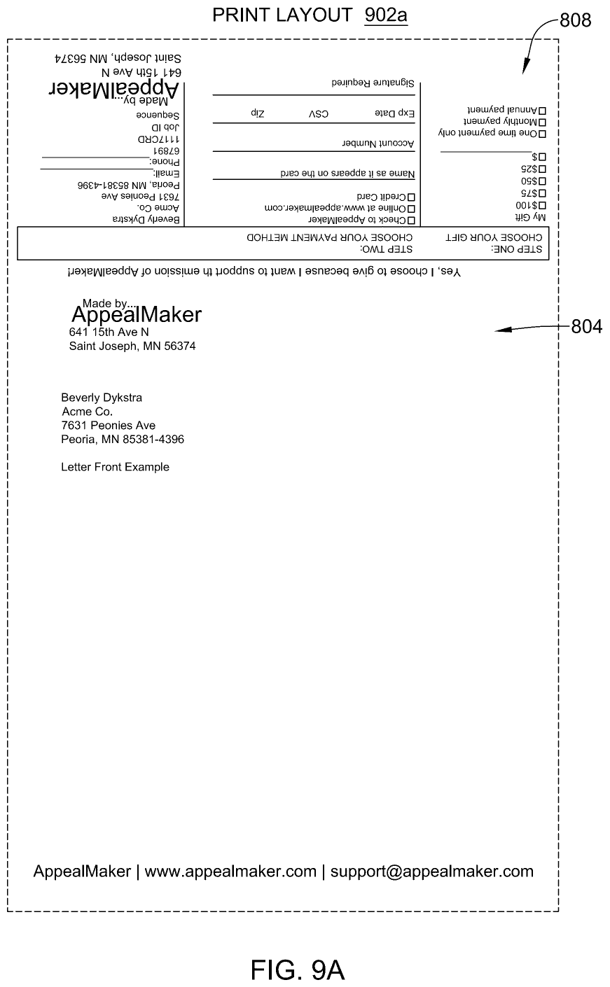

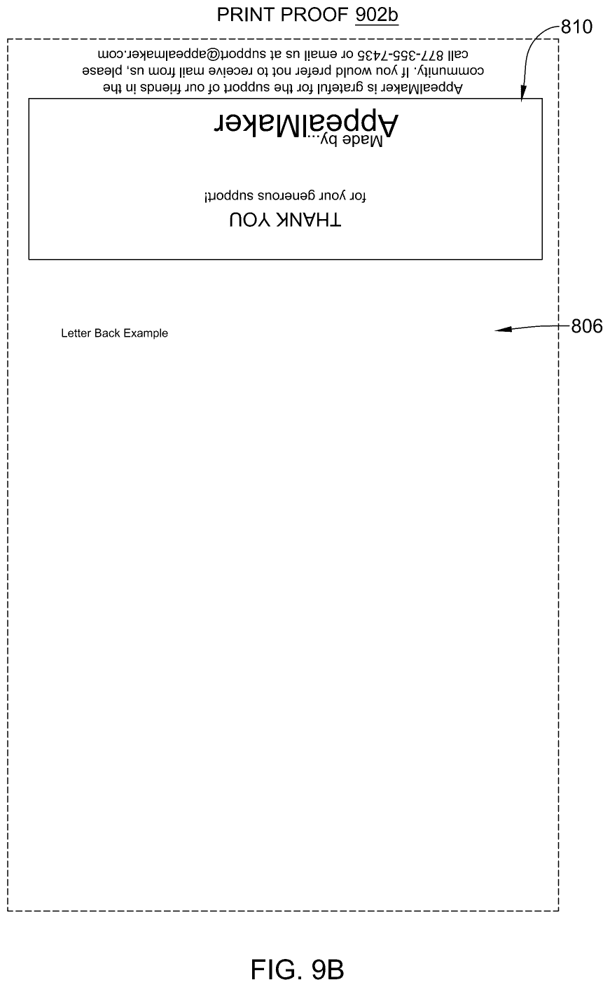

For example, FIG. 8A, FIG. 8B, and FIG. 8C illustrates print proofs while FIG. 9A and FIG. 9B illustrate print layouts, which can be generated as described herein. FIG. 8A illustrates a print proof 802a showing a component 804 (e.g., a letter front); FIG. 8B illustrates a print proof 802b showing a component 806 (e.g., a letter back); while FIG. 8C illustrates a print proof 802c showing component 808 (insert front) and component 810 (insert back).

FIG. 9A illustrates a print layout 902a showing the component 804 and 808 to be printed on the same page. However, as can be seen, the component 808 is rotated 180 degrees. Similarly, FIG. 9B illustrates a print layout 902b, which can be printed on the back of print layout 902a, showing the component 806 and 810 to be printed on the same page. Like component 808, component 810 has been rotated 180 degrees.

As a specific example, a “Donor Renewal” package can have a letter component (8.5″×10.25″), and a remit component (8.5″×3.5″). As outlined above, these are depicted as separate pieces in the GUI (e.g., letter front components, letter back components, remit front component, remit back component, etc.). However, these components can be manipulated and merged for print production. As a specific example, the remit front component can be rotated 180 degrees (e.g., upside down) and merged into the top of the letter front component with a gutter (e.g., ¼″, ½″, or the like) inserted between the components and associated with an 8.5″×14″ sheet for printing (e.g., print layout 902a). Likewise, the letter back and remit back components can be manipulated similarly (e.g., print layout 902b). After these components are printed, the remit component can be cut-off (slit and nest, or the like) from the letter component.

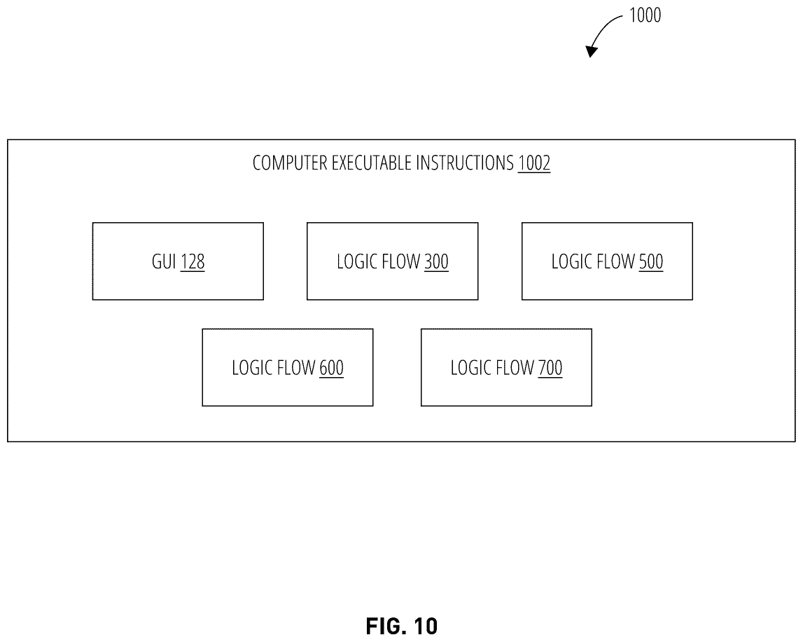

FIG. 10 illustrates computer-readable storage medium 1000. Computer-readable storage medium 1000 may comprise any non-transitory computer-readable storage medium or machine-readable storage medium, such as an optical, magnetic or semiconductor storage medium. In various embodiments, computer-readable storage medium 1000 may comprise an article of manufacture. In some embodiments, computer-readable storage medium 1000 may store computer executable instructions 1002 with which circuitry (e.g., processor 110, or the like) can execute. For example, computer executable instructions 1002 can include instructions to implement operations described with respect to GUI 128, logic flow 300, logic flow 500, logic flow 600, and/or logic flow 700. Examples of computer-readable storage medium 600 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 1002 may include any suitable type of code, such as source code, compiled code, interpreted code, executable code, static code, dynamic code, object-oriented code, visual code, and the like.

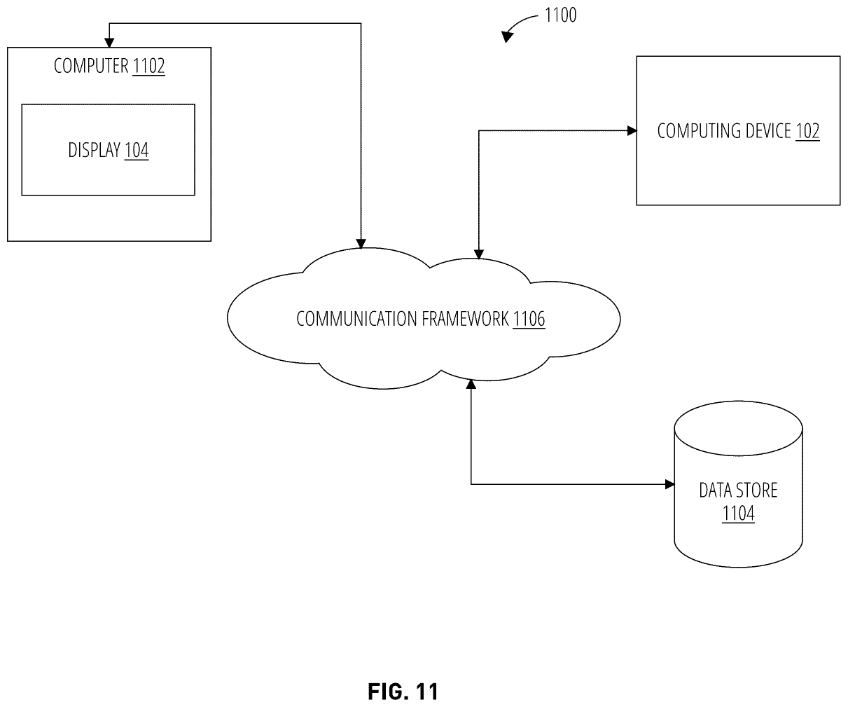

FIG. 11 illustrates an exemplary communications communication architecture 1100 suitable for implementing various embodiments. For example, one or more computing devices may communicate with each other via a communication framework 1106, which may be a network implemented to facilitate electronic communication between devices. The communication architecture 1100 includes various common communications elements, such as a transmitter, receiver, transceiver, radio, network interface, baseband processor, antenna, amplifiers, filters, power supplies, and so forth. The embodiments, however, are not limited to implementation by the communication architecture 1100.

As shown in this figure, the communication architecture 1100 includes a computer 1102 comprising display 104 and computing device 102. Computing device 102 is operatively connected to one or more data stores, such as, data store 1104. Data store 1104 can be employed to store information local to the respective computers (e.g., memory 112, or the like).

Computer 1102 and computing device 102 may communicate information between each other using a communication framework 1106. Computer 1102 and computing device 102 may provide FUSA execution of encryption operations as part of the communicating information between each other using communication framework 1106. The communication framework 1106 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1106 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by computer 1102 and computing device 102. Communication framework 1106 may be any one or combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

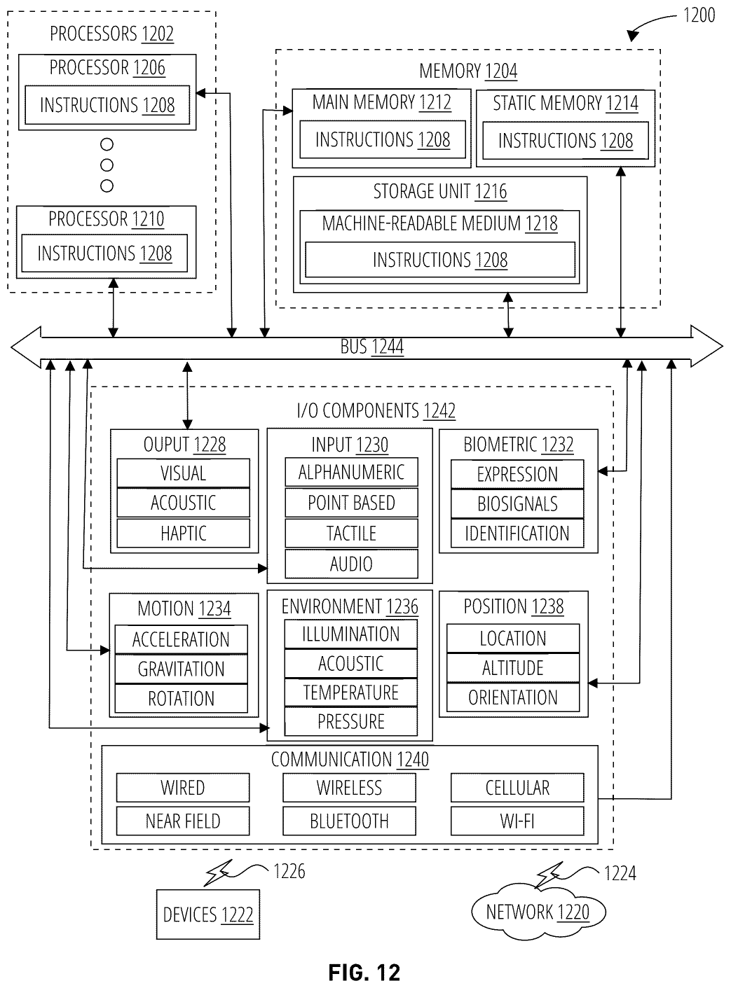

FIG. 12 illustrates a diagrammatic representation of a machine 1200 in the form of a computer system within which a set of instructions may be executed for causing the machine to perform any one or more of the methodologies discussed herein. More specifically, FIG. 12 shows a diagrammatic representation of the machine 1200 in the example form of a computer system, within which instructions 1208 (e.g., software, a program, an application, an applet, an app, or other executable code) for causing the machine 1200 to perform any one or more of the methodologies discussed herein may be executed. For example, the instructions 1208 may cause the machine 1200 to execute logic flow 300 of FIG. 3, logic flow 500 of FIG. 5, logic flow 600 or FIG. 6, logic flow 700 or FIG. 7, or the like. More generally, the instructions 1208 may cause the machine 1200 to provide a WYSIWYG direct-mail mailer editing program comprising a GUI as outlined and described herein.

The instructions 1208 transform the general, non-programmed machine 1200 into a particular machine 1200 programmed to carry out the described and illustrated functions in a specific manner. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1208, sequentially or otherwise, that specify actions to be taken by the machine 1200. Further, while only a single machine 1200 is illustrated, the term “machine” shall also be taken to include a collection of machines 200 that individually or jointly execute the instructions 1208 to perform any one or more of the methodologies discussed herein.

The machine 1200 may include processors 1202, memory 1204, and I/O components 1242, which may be configured to communicate with each other such as via a bus 1244. In an example embodiment, the processors 1202 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1206 and a processor 1210 that may execute the instructions 1208. The term “processor” is intended to include multi-core processors that may comprise two or more independent processors (sometimes referred to as “cores”) that may execute instructions contemporaneously. Although FIG. 12 shows multiple processors 1202, the machine 1200 may include a single processor with a single core, a single processor with multiple cores (e.g., a multi-core processor), multiple processors with a single core, multiple processors with multiples cores, or any combination thereof.

The memory 1204 may include a main memory 1212, a static memory 1214, and a storage unit 1216, both accessible to the processors 1202 such as via the bus 1244. The main memory 1204, the static memory 1214, and storage unit 1216 store the instructions 1208 embodying any one or more of the methodologies or functions described herein. The instructions 1208 may also reside, completely or partially, within the main memory 1212, within the static memory 1214, within machine-readable medium 1218 within the storage unit 1216, within at least one of the processors 1202 (e.g., within the processor's cache memory), or any suitable combination thereof, during execution thereof by the machine 1200.

The I/O components 1242 may include a wide variety of components to receive input, provide output, produce output, transmit information, exchange information, capture measurements, and so on. The specific I/O components 1242 that are included in a particular machine will depend on the type of machine. For example, portable machines such as mobile phones will likely include a touch input device or other such input mechanisms, while a headless server machine will likely not include such a touch input device. It will be appreciated that the I/O components 1242 may include many other components that are not shown in FIG. 12. The I/O components 1242 are grouped according to functionality merely for simplifying the following discussion and the grouping is in no way limiting. In various example embodiments, the I/O components 1242 may include output components 1228 and input components 1230. The output components 1228 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1230 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1242 may include biometric components 1232, motion components 1234, environmental components 1236, or position components 1238, among a wide array of other components. For example, the biometric components 1232 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1234 may include acceleration sensor components (e.g., accelerometer), gravitation sensor components, rotation sensor components (e.g., gyroscope), and so forth. The environmental components 1236 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1238 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1242 may include communication components 1240 operable to couple the machine 1200 to a network 1220 or devices 1222 via a coupling 1224 and a coupling 1226, respectively. For example, the communication components 1240 may include a network interface component or another suitable device to interface with the network 1220. In further examples, the communication components 1240 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1222 may be another machine or any of a wide variety of peripheral devices (e.g., a peripheral device coupled via a USB).

Moreover, the communication components 1240 may detect identifiers or include components operable to detect identifiers. For example, the communication components 1240 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1240, such as location via Internet Protocol (IP) geolocation, location via Wi-Fi® signal triangulation, location via detecting an NFC beacon signal that may indicate a particular location, and so forth.

The various memories (i.e., memory 1204, main memory 1212, static memory 1214, and/or memory of the processors 1202) and/or storage unit 1216 may store one or more sets of instructions and data structures (e.g., software) embodying or utilized by any one or more of the methodologies or functions described herein. These instructions (e.g., the instructions 1208), when executed by processors 1202, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., crasable programmable read-only memory (EPROM), electrically crasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1220 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1220 or a portion of the network 1220 may include a wireless or cellular network, and the coupling 1224 may be a Code Division Multiple Access (CDMA) connection, a Global System for Mobile communications (GSM) connection, or another type of cellular or wireless coupling. In this example, the coupling 1224 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1208 may be transmitted or received over the network 1220 using a transmission medium via a network interface device (e.g., a network interface component included in the communication components 1240) and utilizing any one of a number of well-known transfer protocols (e.g., hypertext transfer protocol (HTTP)). Similarly, the instructions 1208 may be transmitted or received using a transmission medium via the coupling 1226 (e.g., a peer-to-peer coupling) to the devices 1222. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1208 for execution by the machine 1200, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

What is claimed is:

1. A direct-mail component editor system, comprising:
a processor; and
a memory comprising instructions, which when executed by the processor cause the system to:
receive, from a user, an indication of a package of a direct mail mailer;
identify, from a data-object defining the package, components of the package;
identify, from a data-object defining the components, sub-components of the package;
generate, from a data-object defining the sub-components of the package, a graphical user interface (GUI), the GUI comprising a canvas for each one of the sub-components, wherein the canvas comprises an editable graphical depiction of the sub-components;
receiving an indication of a user generated edit to at least one sub-component of the package;
converting the user generated edit from a first data format to a second a data format; and
storing the user generated edit in the second data format to a memory storage location.

2. The direct-mail component editor system of claim 1, wherein the first data format is hypertext markup language (HTML) or HTML 5.

3. The direct-mail component editor system of claim 1, wherein the second data format is java script object notation (JSON), extensible markup language (XML), or YAML ain′t markup language (YAML).

4. The direct-mail component editor system of claim 1, wherein the instructions when executed to generate, from the data-object defining the sub-components of the package, the GUI further cause the system to:
identify, for a first one of the sub-components, dimensions of the first sub-component;
generate the canvas for the first sub-component based in part on the dimensions of the first sub-component;
add fixed elements for the first sub-component to the canvas;
add user editable elements for the first sub-component to the canvas; and
store an indication of the canvas for the first sub-component to the memory storage location.

5. The direct-mail component editor system of claim 4, wherein the instructions when executed to generate, from the data-object defining the sub-components of the package, the GUI further cause the system to:
identify, for a second one of the sub-components, dimensions of the second sub-component;
generate the canvas for the second sub-component based in part on the dimensions of the sub-component;
add fixed elements for the second sub-component to the canvas;
add user editable elements for the second sub-component to the canvas; and
store an indication of the canvas for the second sub-component to the memory storage location.

6. The direct-mail component editor system of claim 5, wherein the GUI comprises a component navigation bar comprising an indication of the first sub-component and the second sub-component and wherein the instructions when executed to generate, from the data-object defining the sub-components of the package, the GUI further cause the system to:
determine whether the first sub-component or the second sub-component is selected in the navigation bar; and
center the canvas for the first sub-component in the GUI based on a determination that the first sub-component is selected in the navigation bar; or
center the canvas for the second sub-component in the GUI based on a determination that the second sub-component is selected in the navigation bar.

7. The direct-mail component editor system of claim 5, wherein the second data format defines an X and Y coordinate of at least one user generated element with respect to a one of the canvases.

8. The direct-mail component editor system of claim 1, wherein the system is a software-as-a-service (SaaS) system accessible over the Internet.

9. A computer-readable storage medium, comprising instructions that when executed by a processor of a direct-mail component editor system cause the system to:
receive, from a user, an indication of a package of a direct mail mailer;
identify, from a data-object defining the package, components of the package;
identify, from a data-object defining the components, sub-components of the package;
generate, from a data-object defining the sub-components of the package, a graphical user interface (GUI), the GUI comprising a canvas for each one of the sub-components, wherein the canvas comprises an editable graphical depiction of the sub-components;
receiving an indication of a user generated edit to at least one sub-component of the package;
converting the user generated edit from a first data format to a second a data format; and
storing the user generated edit in the second data format to a memory storage location.

10. The computer-readable storage medium of claim 9, wherein the first data format is hypertext markup language (HTML) or HTML 5.

11. The computer-readable storage medium of claim 9, wherein the second data format is java script object notation (JSON), extensible markup language (XML), or YAML ain′t markup language (YAML).

12. The computer-readable storage medium of claim 9, wherein the instructions when executed to generate, from the data-object defining the sub-components of the package, the GUI further cause the system to:
identify, for a first one of the sub-components, dimensions of the first sub-component;
generate the canvas for the first sub-component based in part on the dimensions of the first sub-component;
add fixed elements for the first sub-component to the canvas;
add user editable elements for the first sub-component to the canvas; and
store an indication of the canvas for the first sub-component to the memory storage location.

13. The computer-readable storage medium of claim 12, wherein the instructions when executed to generate, from the data-object defining the sub-components of the package, the GUI further cause the system to:
identify, for a second one of the sub-components, dimensions of the second sub-component;
generate the canvas for the second sub-component based in part on the dimensions of the sub-component;
add fixed elements for the second sub-component to the canvas;
add user editable elements for the second sub-component to the canvas; and
store an indication of the canvas for the second sub-component to the memory storage location.

14. The computer-readable storage medium of claim 13, wherein the GUI comprises a component navigation bar comprising an indication of the first sub-component and the second sub-component and wherein the instructions when executed to generate, from the data-object defining the sub-components of the package, the GUI further cause the system to:
determine whether the first sub-component or the second sub-component is selected in the navigation bar; and
center the canvas for the first sub-component in the GUI based on a determination that the first sub-component is selected in the navigation bar; or
center the canvas for the second sub-component in the GUI based on a determination that the second sub-component is selected in the navigation bar.

15. The computer-readable storage medium of claim 13, wherein the second data format defines an X and Y coordinate of at least one user generated element with respect to a one of the canvases.

16. A computer implemented method for a direct-mail component editor system, comprising:
receiving, at a processor of a direct-mail component editor system from a user of the system, an indication of a package of a direct mail mailer;
identifying, by the processor from a data-object defining the package, components of the package;
identifying, by the processor from a data-object defining the components, sub-components of the package;
generating, by the processor from a data-object defining the sub-components of the package, a graphical user interface (GUI), the GUI comprising a canvas for each one of the sub-components, wherein the canvas comprises an editable graphical depiction of the sub-components;
receiving, by the processor from the user, an indication of a user generated edit to at least one sub-component of the package;
converting, by the processor, the user generated edit from a first data format to a second a data format; and
storing, by the processor, the user generated edit in the second data format to a memory storage location.

17. The computer implemented method of claim 16, wherein the first data format is hypertext markup language (HTML) or HTML 5.

18. The computer implemented method of claim 16, wherein the second data format is java script object notation (JSON), extensible markup language (XML), or YAML ain′t markup language (YAML).

19. The computer implemented method of claim 16, further comprising:
identifying, by the processor for a first one of the sub-components, dimensions of the first sub-component;
generating, by the processor, the canvas for the first sub-component based in part on the dimensions of the first sub-component;
adding, by the processor, fixed elements for the first sub-component to the canvas;
adding, by the processor, user editable elements for the first sub-component to the canvas; and
storing, by the processor, an indication of the canvas for the first sub-component to the memory storage location.

20. The computer implemented method of claim 19, further comprising:
identifying, by the processor, for a second one of the sub-components, dimensions of the second sub-component;
generating, by the processor, the canvas for the second sub-component based in part on the dimensions of the sub-component;
adding, by the processor, fixed elements for the second sub-component to the canvas;
adding, by the processor, user editable elements for the second sub-component to the canvas;
storing, by the processor, an indication of the canvas for the second sub-component to the memory storage location;
determining, by the processor, whether the first sub-component or the second sub-component is selected in the navigation bar; and
centering, by the processor, the canvas for the first sub-component in the GUI based on a determination that the first sub-component is selected in the navigation bar; or
centering, by the processor, the canvas for the second sub-component in the GUI based on a determination that the second sub-component is selected in the navigation bar.
